(19) United States
(12) Patent Application Publication
(10) Pub. No.: US 2009/0039150 A1
(43) Pub. Date: Feb. 12, 2009

(54) Remote handheld payment device and method

(76) Inventor: Isaac Lay, Brea, CA (US)

Correspondence Address: ZUBER & TAILLIEU LLP;SUITE 300, 10866 WILSHIRE BLVD, LOS ANGELES, CA, 90024, US

(21) Appl. No.: 11/890,556

(22) Filed: Aug. 6, 2007

(51) Int. Cl. G06Q 40/00

(52) U.S. Cl. 235/379

(57) ABSTRACT

Embodiments of the present invention provide a remote payment device that is simple, versatile, and easy to use, accepts payments by charge cards or cash, and handles a split-check scenario in a simple and flexible manner. In one embodiment, a remote payment device for processing payment of a bill to allow payment to be shared by a plurality of customers comprises a charge card reading unit configured to read account information from a charge card; a data input unit for a user to enter data; a display unit; and a processor configured to process account information read from the charge card reading unit and data received from the data input unit and to display information on the display unit. The processor is configured to prompt entry of data by the data input unit to specify a number of one or more customers to make payment of a bill, and to allow each customer to specify any amount of the bill to pay and any amount of a tip to be added and a method of payment.

### FIELD OF THE INVENTION

The invention relates generally to payment device and method for commercial transactions and, more particularly, to a remote handheld payment device and a method for processing payment in a restaurant or the like to allow payment of a bill by one or more customers by charge card or cash.

### BACKGROUND ART

In restaurants, a bill is presented to the customers at the table at the end of the meal. If the payment is made by credit card, the waiter or waitress must return to the table to pick up the credit card and bill, process the payment at a central payment processing station, and bring the credit card and receipt back to the table. The situation becomes complicated when the customers wish to split the bill in a split-check scenario, especially if the customers use different payment methods and/or if the bill is not to be split equally among the customers, and even more so if the number of customers at the table is more than a few. The waiter or waitress will need to memorize or write down the names of the customers, payment methods, and amounts to be paid. Mistakes can be easily made. This also makes tipping more difficult for the customers, and can lead to under-tipping which is undesirable for the waiter or waitress.

Remote payment terminals have been proposed. They have various drawbacks. For example, some do not process debit cards. Others are complicated and difficult to use. Still others have many features but expensive to manufacture. For the split-check scenario, one proposed scheme splits the check according to items ordered by the customers.

### BRIEF SUMMARY OF THE INVENTION

Embodiments of the present invention provide a remote payment device that is simple, versatile, and easy to use, accepts payments by charge cards or cash, and handles a split-check scenario in a simple and flexible manner. As used herein, the term “charge cards” encompasses credit cards, debit cards, gift cards, and the like, whether a PIN number is necessary for processing payment or not. In the split-check scenario, each customer is free to choose the amount to pay as a portion of the bill without regard to the items that customer ordered and to choose the tip to pay. After the customers make the payment selection, the remote payment device provides a payment summary listing the payments selected and calculates the tip as a percentage of the bill, and gives the customers the option to adjust the payment of the bill and/or the tip.

In accordance with an aspect of the present invention, a remote payment device for processing payment of a bill to allow payment to be shared by a plurality of customers comprises a charge card reading unit configured to read account information from a charge card; a data input unit for a user to input data; a display unit; and a processor configured to process account information read from the charge card reading unit and data received from the data input unit and to display information on the display unit. The processor is configured to prompt entry of data by the data input unit to specify a number of one or more customers to make payment of a bill, and to allow each customer to specify any amount of the bill to pay and any amount of a tip to be added and a method of payment.

In some embodiments, the processor is configured to allow each customer to specify any amount of the bill to pay by allowing the customer to enter using the data input unit any items of the bill to pay and summing the items entered by the customer to calculate a total from the bill to be paid by the customer. The processor is configured to allow each customer to specify any amount of a tip to be added by specifying a dollar amount of the tip or a percentage of the portion of the bill to be paid as the tip. The processor is configured to display a payment summary including an amount specified by each customer to be paid on the display unit and to display a total amount of the tip, and to allow the customer to edit the amount before finalizing payment. The processor is configured to display an amount specified by each customer to be paid on the display unit and, for payment by a charge card, the processor is configured to load only a name and/or last four digits on the charge card for display.

In specific embodiments, after a customer specifies an amount of the bill to be paid, the processor is configured to calculate and display any remaining amount of the bill that needs to be paid. For payment by a debit card, the processor is configured to prompt the customer to enter a PIN number using the data input unit. For payment by a credit card, the processor is configured to prompt the customer to place the credit card in a slot on the remote payment device. For payment by cash, the processor is configured to prompt entry of a cash amount to be provided by the customer, and any excess cash provided by the customer is to be returned as change. The processor is configured to calculate the change to be returned to the customer. The remote payment device may further include a wireless interface to communicate payment information wirelessly with a central payment processing station. The remote payment device may further include an encryption module to encrypt account information of a charge card and any PIN number provided by the customer.

In accordance with another aspect of the invention, a remote payment device for processing payment of a bill shared by a plurality of customers comprises a charge card reading unit configured to read account information from a charge card; a data input unit for a user to input data; a display unit; and a processor configured to process account information read from the charge card reading unit and data received from the data input unit and to display information on the display unit. The processor is configured to allow each customer to specify any amount of the bill to pay without regard to items on the bill ordered or consumed by the customer and any amount of a tip to be added and a method of payment.

Another aspect of the present invention relates to a method of remotely processing payment of a bill to allow payment to be shared by a plurality of customers. The method comprises prompting entry of a number of one or more customers to make payment of a bill; and prompting entry of data for each customer to specify any amount of the bill to pay without regard to items on the bill ordered or consumed by the customer and any amount of a tip to be added and a method of payment.

In some embodiments, prompting entry of data for each customer to specify any amount of the bill to pay comprises receiving from the customer data specifying any items of the bill to pay; and summing the items specified by the customer to calculate a total from the bill to be paid by the customer. Prompting the entry of data for each customer to specify any amount of a tip to be added comprises receiving from the customer data specifying a dollar amount of the tip or a percentage of the portion of the bill to be paid as the tip. The method may further comprise displaying a payment summary including an amount specified by each customer to be paid on the display unit and to display a total amount of the tip, and allowing the customer to edit the amount before finalizing payment.

In specific embodiments, the method further comprises displaying an amount specified by each customer to be paid; and for payment by a charge card, loading only a name and/or last four digits on the charge card for display. The method further comprises, after a customer specifies an amount of the bill to be paid, calculating and displaying any remaining amount of the bill that needs to be paid. The method further comprises, for payment by a debit card, prompting the customer to enter a PIN number. The method further comprises, for payment by a credit card, prompting the customer to place the credit card in a slot on a remote payment device. The method further comprises, for payment by cash, prompting entry of a cash amount to be provided by the customer, wherein any excess cash provided by the customer is to be returned as change. The method further comprises calculating the change to be returned to the customer. The method further comprising communicating payment information wirelessly with a central payment processing station. The method further comprises encrypting account information of a charge card and any PIN number provided by the customer.

These and other aspects of the invention are described in further detail below and shown in the accompanying drawings.

### BRIEF DESCRIPTION OF THE DRAWINGS

FIG. 1 is a perspective view of a remote payment device according to one embodiment of the invention.

FIG. 2 is a schematic diagram of a remote payment system showing the relationship between a central payment processing station and a plurality of remote payment devices according to one embodiment of the invention.

FIG. 3 is a block diagram schematically illustrating the electronic components of the remote payment device according to one embodiment of the invention.

FIG. 4 is a flow diagram illustrating a remote payment process including a whole-check payment process and a split-check payment process according to one embodiment of the invention.

FIG. 5 is a flow diagram illustrating a charge card processing procedure in the split-check payment process of FIG. 4.

FIG. 6 is a flow diagram illustrating additional processing steps for payment by a credit card in the charge card processing step of FIG. 5.

FIG. 7 is a flow diagram illustrating a cash processing procedure in the split-check payment process of FIG. 4.

FIG. 8 is a flow diagram illustrating a payment summary edit step in the split-check payment process of FIG. 4.

FIG. 9 is a flow diagram illustrating additional processing steps for the whole-check payment process of FIG. 4.

FIG. 10 is a flow diagram illustrating a charge card processing step in the whole-check payment process of FIG. 9.

FIG. 11 is a flow diagram illustrating a cash processing step in the whole-check payment process of FIG. 9.

### DETAILED DESCRIPTION OF PREFERRED EMBODIMENTS OF THE INVENTION

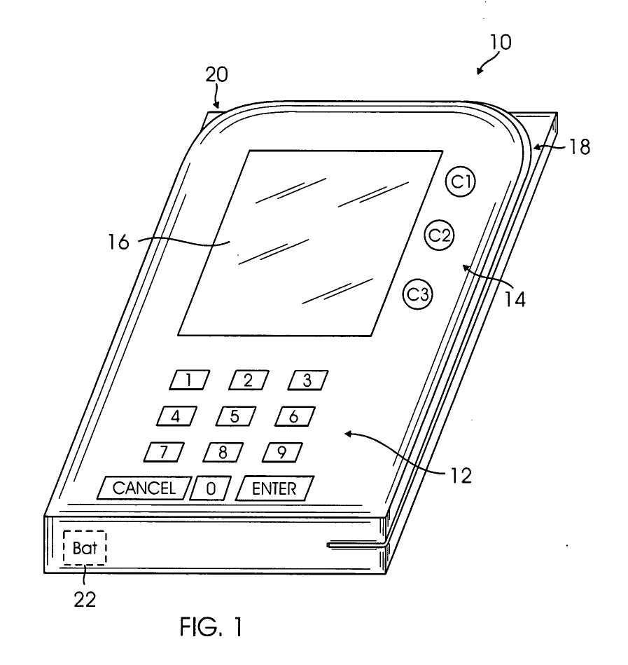

FIG. 1 shows one embodiment of a handheld, remote payment device or pad 10 which includes a keypad 12 for data input by a user, control buttons 14, a display 16 to provide a graphical user interface, a card reader 18 for reading a charge card, a slot 20 for holding one or more charge cards, and a battery 22. The keypad 12 includes a typical num pad with standard layout for user familiarity to minimize entry errors, and additional control keys such as CANCEL and ENTER. As discussed below, the ENTER key is consistently used to progress the payment process to the next step. The display 16 may be a liquid crystal display (LCD) or any suitable type of display to present information and instructions to the user. The card reader 18 is typically a magnetic strip reader having a magnetic head but may be any suitable type of reader to read data such as account and security information from a charge card. For example, the card reader may instead be a bar code reader, a reader for a contactless RFID (radiofrequency identification) card, a biometric reader, or the like. For simplicity of construction and cost, user input is made via the keypad 12. In alternative embodiments, however, the display 16 may be a touch-screen display that allows the user to enter input or to form a signature using a stylus or the like. The battery 22 may be a rechargeable battery, and may be built into the remote payment device 10 but is desirably removable for charging and replaceable by a charged battery. The remote payment device 10 may be built into a commonly used leather bound check presenter or the like.

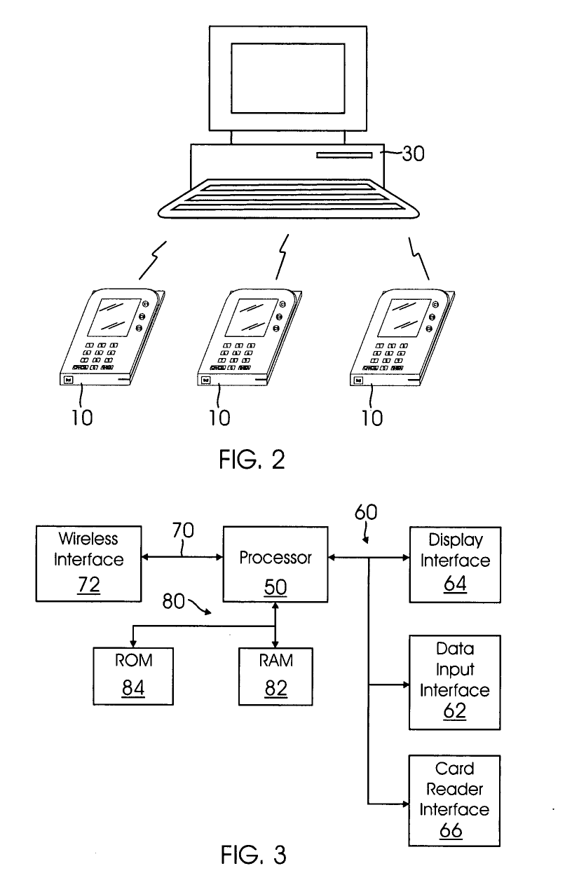

FIG. 2 shows a schematic diagram of a remote payment system showing the relationship between a central payment processing station 30 and a plurality of remote payment devices 10. The central payment processing station 30 may be a point-of-sale (POS) terminal, a cash register, or the like. Payment by cash can be processed at the processing station 30. Payment by debit card is typically processed by the remote payment device 10 and the debit card payment information is transmitted to the central payment processing station 30, preferably wirelessly. Payment by credit card is typically processed at the central payment processing station 30. Alternatively, it can be processed by the remote payment device 10 and transmitted to the central payment processing station 30. Credit card authorization is performed by establishing a communication link with a financial organization that processes credit card authorization requests, through a wide area network (WAN) connection or a telephone link or the like. In general, receipts will be printed at the central payment processing station 30 so as to keep the remote payment device 10 simple and light in construction for handheld operation. In alternative embodiments, receipt printing capability may be added to the remote payment device 10.

FIG. 3 is a block diagram schematically illustrating the electronic components of the remote payment device 10. A processor 50 directs operation of the remote payment device 10. An input/output (I/O) bus 60 connects the processor 50 to various input/output interface circuitries for interface with the input/output devices for the user as shown in FIG. 1. The input/output interfaces include a data input interface 62 for the data input unit or keypad 12, a display interface 64 for the output unit or display 16, and a card reader interface 66 for the card reader 18. The card reader interface 66 typically includes a decoder for decoding data read from the card. The processor 50 is also coupled to wireless network interface circuitry 72. The wireless network interface circuitry 72 enables the processor 50 to transmit and receive data wirelessly between the remote payment device 10 and the central payment processing station 30 of FIG. 2 or other system elements. Typically, a widely deployed wireless network standard, such as the IEEE 802.11 standard, will be utilized to implement the wireless network. The processor 50 is also preferably coupled to a random access memory (RAM) 82 and an electrically erasable and programmable read only memory (EEPROM) 84 for firmware. The EEPROM 84 stores operating code for the remote payment device 10 including an encryption/decryption program or module and certain non-volatile data such as public and private key information as well as other security data fields. The EEPROM 84 is preferably reprogrammable.

The remote payment device 10 is preferably capable of wirelessly transmitting transaction information to the central payment processing station 30. The remote payment device 10 ensures that all account information is encrypted prior to transmitting the information to the central payment processing station 30 using, for example, the IEEE 802.11 standard. Encryption keys using government required cryptography are injected into the wireless remote payment devices 10 prior to restaurant installation. This ensures that immediately after a customer swipes his or her card and enters the PIN number, encryption occurs prior to transmission of the transaction information from the remote payment device 10 to the central payment processing station 30. Each remote payment device 10 is injected with an encryption key. For example, the account information read by the card reader 18 of the remote payment device is encrypted using the public key of the central payment processing station 30 prior to transmission to the central payment processing station 30.

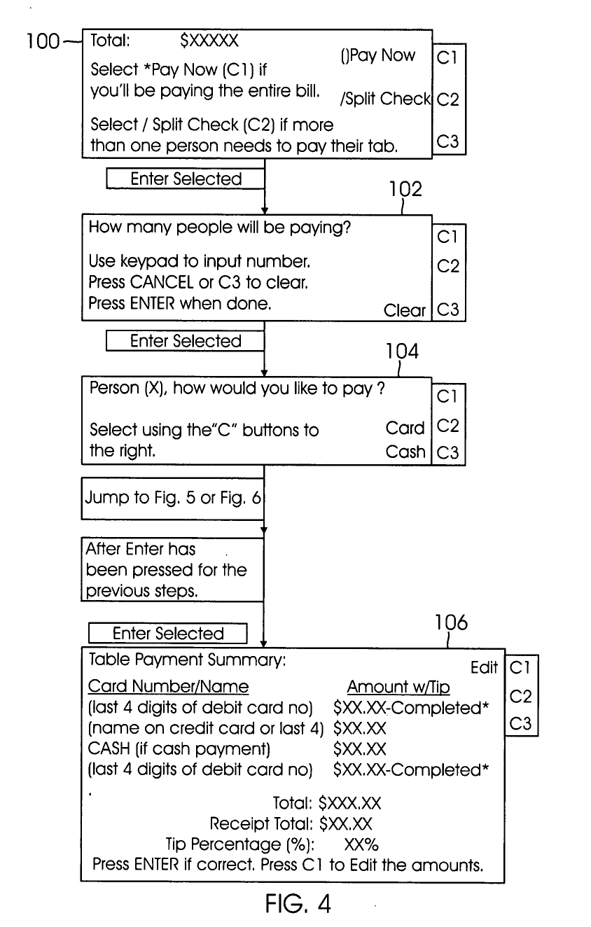

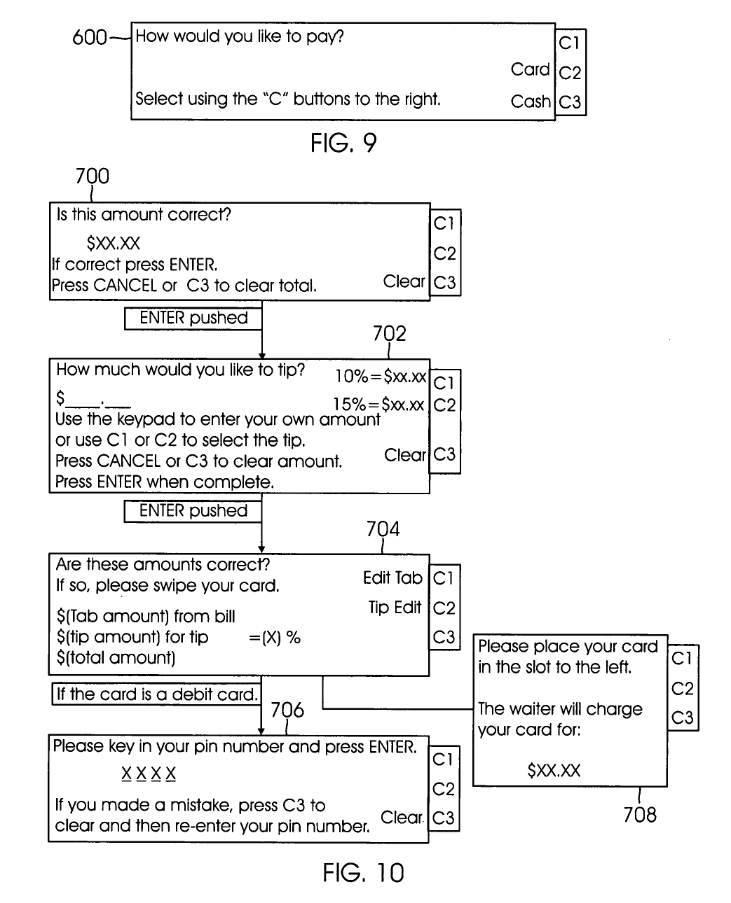

FIG. 4 is a flow diagram A0 illustrating a remote payment process including a whole-check payment process and a split-check payment process for a table service restaurant setting according to one embodiment of the invention. Step 100 illustrates the first step in the process and further illustrates a preferred content which will be displayed on the display 16 of the device when initiating a bill payment process in accordance with a preferred embodiment of the present invention. As shown in FIG. 4, the total bill amount is preferably shown on the device and it first prompts the user to select one of two options. In the first option, the user can press control button C1 on the remote payment device 10 to select a whole-check payment process or press control button C2 to select a split-check payment process. The whole-check payment process takes the user to step 600 as described in connection with FIGS. 9-11 below.

If the split-check process is selected, the process moves to step 102 of FIG. 4 in which the device then prompts the user to enter the number of customers amongst whom the check will be split using the keypad 12—i.e. the number of people paying on the bill/tab. In a split check scenario, the number will typically be at least two, but may be greater. In a preferred embodiment, if a mistake is made, the user may push the CANCEL key or control button C3 on the keypad 12 to clear an entry. When a correct entry is made, the user can press the ENTER key on the keypad 12 to complete the step.

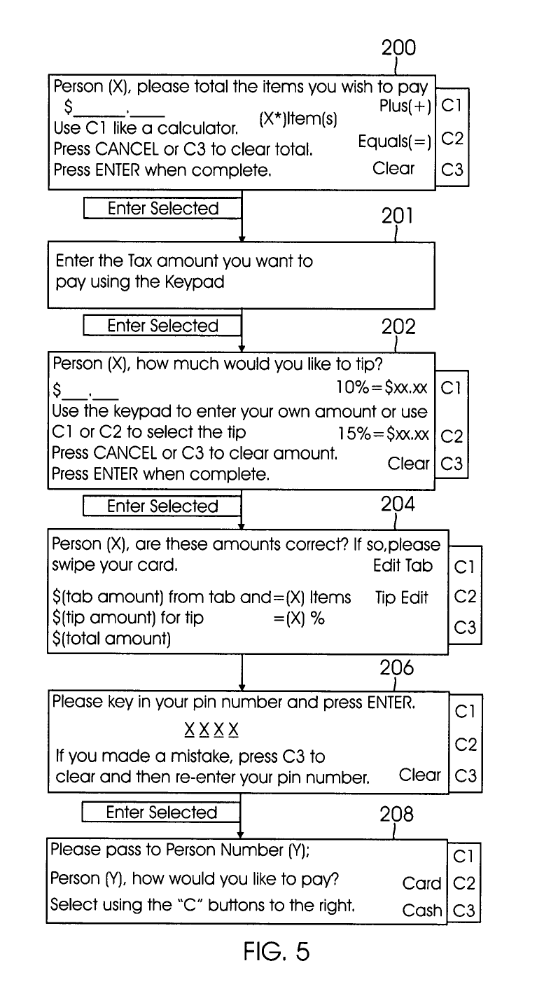

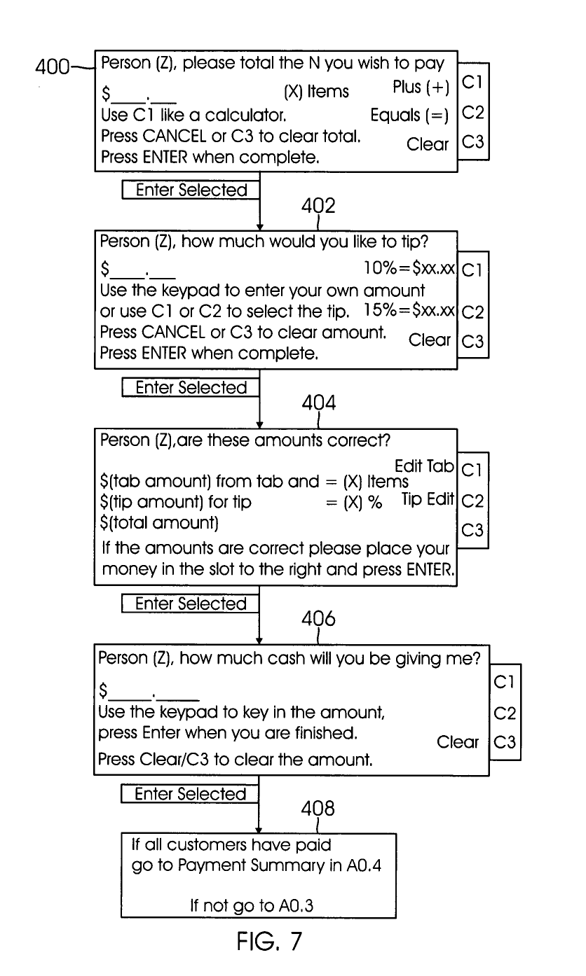

Once the number of payees has been entered, the device then prompts the first customer making payment to indicate how payment will be made—i.e. a method of payment. The user can press button C2 for payment by a charge card, which leads to step 200 in the flow diagram FIG. 5, or, alternative, the user may select/press button C3 for payment by cash, which leads to step 400 in flow diagram FIG. 7.

FIG. 5 is a flow diagram illustrating a charge card processing procedure in the split-check payment process of FIG. 4. In step 200, the device of the present invention preferably asks the user to total the items he or she wishes to pay, which may be either the items that customer has ordered or any portion of the bill without regard to the items ordered by that customer. The user can enter the amount using the keypad 12. For multiple items or entries, the user can press button C1 as a “+” sign for addition and press button C2 as a “=” sign to show the total. The user can press the CANCEL key or button C3 to clear. When the customer has entered the correct portion of the bill he or she wishes to pay, the ENTER key is pressed to complete this step. In a preferred embodiment, the device is configured to also show the number of items entered and summed to arrive at the total.

In step 201, the device is configured to automatically calculate the tax on the amount(s) entered by the user. Accordingly, each device is designed specifically for and preprogrammed with tax rate information for the specific state in which it is purchased/shipped for use. In a preferred embodiment, once the device automatically calculates the tax, it will preferably prompt the user to accept this amount by asking the user/customer whether he/she wishes to pay this tax amount and/or some other tax amount, thereby allowing a user to enter a different amount to be applied as tax.

In step 202, the device asks the customer to specify a tip amount using the keypad 12. For the customer's convenience and reference, the device will preferably display content shown in step 202, which preferably includes the amount for a 10% tip and the amount for a 15% tip. The customer can press button C1 to select 10% or button C2 to select 15%. In other embodiments, the customer may have the option of specifying a percentage using the keypad 12 instead of entering a dollar amount for the tip. The remote payment device 10 will automatically calculate the tip amount based on the percentage. Again, the customer can press the CANCEL key or button C3 to clear. When the customer has entered the tip he or she wishes to pay, the ENTER key is pressed to complete this step.

At step 204, the device preferably shows a summary of the portion of the bill and the tip to be paid as specified by the customer, and asks the customer to swipe his or her charge card using the card reader 18 if the amounts are correct. Alternatively, if the charge card is not being processed by the remote payment device 10 (such as a credit card as opposed to a debit card), the user may key in the last four digits of the charge card number instead of swiping the charge card. If the charge card is a contactless RFID card, the card is moved over the RFID reader. If a biometric reader is used, the customer will expose a finger or an iris or some other biometric identifier to the biometric reader.

In the event of a pin-based debit card, a contactless credit card, or a biometric transaction, the charge card payment transaction will begin at the table using the remote payment device 10. Upon transaction completion, a request to print the receipt for the specified transactions will be marked as pending within the central payment processing station 30 until the waiter or waitress approves the printing request. This feature is beneficial in that other waiters or waitresses will not confuse the receipt that would otherwise immediately print at the central payment processing station 30. This allows the correct waiter or waitress to arrive at the central payment processing station 30 and charge the credit cards that might make up the other payment methods on the split check. Once all payment methods have been processed and the entire check has been paid, the waiter or waitress can elect to print all transaction receipts for the table at the same time for delivery to the respective customers.

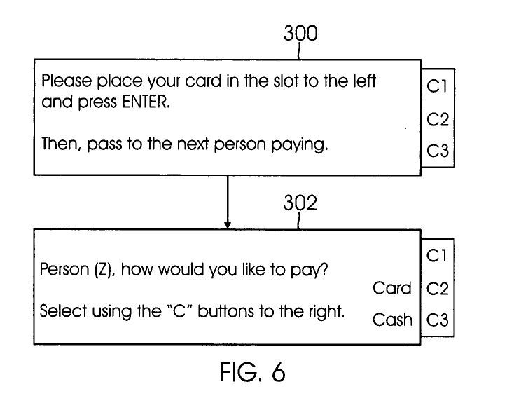

If any changes are desired, however, the customer can press button C1 to edit the tab or portion of the bill to be paid or press button C2 to edit the tip only. Pressing button C1 takes the user back to step 200, while pressing button C2 takes the user back to step 202 and the amount of the tab specified previously is stored. If the charge card is a credit card, the process goes to step 300 shown in flow diagram FIG. 6. If the charge card is a debit card, the process continues in FIG. 5 to step 206.

In step 206, the device preferably prompts the customer to enter the PIN number using the keypad 12. If the customer makes a mistake, he or she can press the CANCEL key or button C3 to clear and re-enter the PIN number. After the correct PIN number is entered, the customer can press the ENTER key to complete this step. In a preferred embodiment, the remote payment device 10 processes the debit card payment so that there is no need to wait for a payment confirmation at the central payment processing station 30. The remote payment device 10 stores in memory the last four digits of the debit card number and the total amount including tip that is paid. The screen layout of the display content desirably is similar to that for a typical ATM transaction and user friendly, where all prompts will ask a question in order to direct the user to the desired response.

In step 208 the device prompts the current customer to pass the remote payment device to the customer making the next payment. That customer has the option of paying by charge card by pressing button C2 or paying by cash by pressing button C3, similar to step 104, as discussed an described. Dependent upon that next customer's response, the device essentially takes the process back to step 104 in the split-check scenario of FIG. 4 and the process loop continues until all the parties to the split check have entered their payment amounts.

If the charge card read at the conclusion of step 204 is a credit card, the process moves to flow diagram FIG. 6. In step 306, the device then prompts the customer to place the card in the slot 20 provided on the remote payment device 10, and to press ENTER to complete the step. The remote payment device 10 is then passed to the customer making the next payment selection.

In step 302, the device prompts the next customer to press button C2 to pay by charge card or to press button C3 to pay by cash. Step 302 essentially takes the process back to step 104 associated with the split-check scenario of FIG. 4 and the process loop continues until all the parties to the split check have entered their payment amounts.

When the cash option is selected in step 104 in the split-check scenario of FIG. 4, the process moves to flow diagram FIG. 7. In step 400, the device then prompts the user/customer paying by cash to total the items he or she wishes to pay, which may be either the items that customer has ordered or any portion of the bill without regard to the items ordered by that customer. The user can enter the amount using the keypad 12. For multiple items or entries, the user can press button C1 as a “+” sign for addition and press button C2 as a “=” sign to show the total. The user can press the CANCEL key or button C3 to clear. When the customer has entered the correct portion of the bill he or she wishes to pay, the ENTER key is pressed to complete this step. In a preferred embodiment the device displays the number of items entered and summed to arrive at the total and the total amount to be paid for by cash.

In step 402, the device prompts the customer to specify a tip amount using the keypad 12. For the customer's convenience and reference, the device is configured to display the amount for a 10% tip and the amount for a 15% tip. The customer can press button C1 to select the 10% or button C2 to select the 15% amount. Alternatively, the customer may enter a specific dollar amount. In other embodiments, the customer may have the option of specifying a different percentage using the keypad 12 instead of entering a dollar amount for the tip. Again, the customer can press the CANCEL key or button C3 to clear. When the customer has entered the tip he or she wishes to pay, the ENTER key is pressed to complete this step.

In step 404 the device then displays a summary of the portion of the bill and the tip to be paid as specified by the customer, and asks the customer to confirm by pressing the ENTER key and prompts the customer to place the cash in the slot 20 of the remote payment device 10. If the amounts are not correct, the customer can press button C1 to edit the tab or portion of the bill to be paid or press button C2 to edit the tip only. Pressing button C1 takes the user back to step A3.1, while pressing button C2 takes the user back to step A3.2 and the amount of the tab specified previously is stored.

In step 406 the device prompts the customer to enter the amount of cash he or she has placed in the slot 20 using the keypad 12. The customer can press the CANCEL key or button C3 to clear any mistakes. The remote payment device 10 preferably calculates the amount of change, if any, that needs to be returned to the customer. As shown in block 408, if all customers have paid, the process moves to the payment summary of step 106 in FIG. 4. Otherwise, the process takes the user back to step 104 associated with display content 104 in the split-check scenario of FIG. 4 and the process loop continues until all the parties to the split check have entered their payment amounts. In some embodiments, after one customer has selected the payment method and amount, the remote payment device 10 may optionally track the payment amounts so as to calculate and display any remaining amount of the bill that needs to be paid for the convenience and reference of the next customer.

Referring to the payment summary shown in step 106 of FIG. 4, the device is preferably configured to show the payment summary by listing each payment method and the corresponding amount that has been specified by the customer. The accumulated total payment entered by the customers is shown. The difference between the total payment and the receipt total is the tip, which is displayed in percentage. For a charge card, the last four digits of the card number are typically shown. If the charge card is a credit card, the name on the card may be shown instead of, or in addition to, the last four digits of the credit card number. For payment by a credit card, the processor is preferably configured to load only a name and/or last four digits on the charge card for display. If the remote payment device 10 is used to process a debit card payment with a PIN number, the payment is completed as shown on the display and no changes can be made. For other payments, the customer will have the opportunity to review the payment summary and edit the amounts by pressing button C1. If no changes are necessary, the user can press the ENTER key to complete the remote payment process. The waiter or waitress will complete the transaction at the central payment processing station 30 or the like.

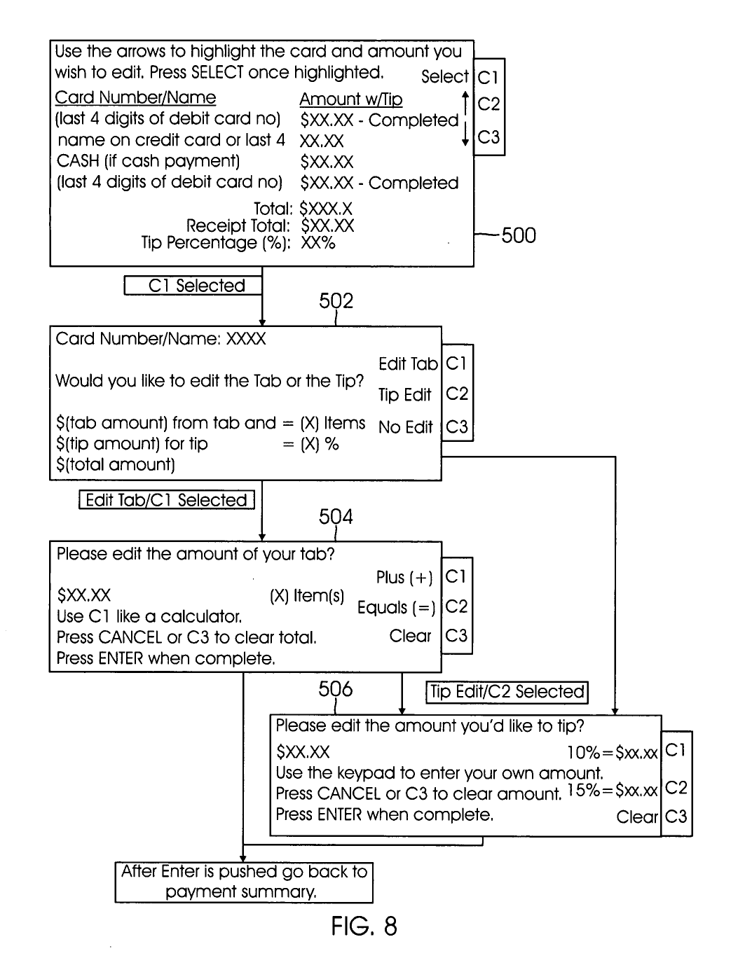

FIG. 8 is a flow diagram illustrating a payment summary edit step in the split-check payment process of FIG. 4 if the edit key C1 is pressed in step 106. In step 500, the device prompts the user to press control button C2 for upward arrow or control button C3 for downward arrow to navigate among the individual payment amounts and highlight any of them. When the payment amount that needs to be edited is highlighted, the user can press control button C1 to select that payment amount, which leads to step 502. To cancel the edit and return to the payment summary step 502, the user can press the CANCEL key.

In step 502, the device shows the tab amount as a portion of the bill and the tip amount, and preferably also shows the number of items selected from the bill and the tip percentage. The user can press button C1 to edit the tab or press button C2 to edit the tip. Pressing button C1 takes the user to step 504, which allows the user/customer to edit the amount of the tab he/she is paying, while pressing button C2 takes the user to step 506, which allows the user/customer to edit the amount of tip he or she is paying. The user can press the CANCEL key or button C3 to cancel the edit and return to the payment summary.

In step 504, the device preferably prompts the user/customer to total the items he or she wishes to pay, which may be either the items that customer has ordered or any portion of the bill without regard to the items ordered by that customer. The user can enter the amount using the keypad 12. For multiple items or entries, the user can press button C1 as a “+” sign for addition and press button C2 as a “=” sign to show the total. The user can press the CANCEL key or button C3 to clear. When the customer has entered the correct portion of the bill he or she wishes to pay, the ENTER key is pressed to complete this step. Display content 504 can also show the number of items entered and summed to arrive at the total. The process preferably returns to step 502 to show the revised tab amount and the tip amount as a percentage of the revised tab, and allows the user to edit the tip by pressing C2 if desired. If no further edit is necessary, the user can press button C3 to return to the payment summary. Alternatively, when the ENTER key is pressed in step 506, the process returns to the payment summary edit step 500. Further changes can be made by moving up and down among the payments and pressing button C1 to select a payment to edit. If no more changes are necessary, the user can press the CANCEL key to return to the payment summary.

In step 506 the device prompts the customer to specify a tip using the keypad 12. For the customer's convenience and reference the device is preferably configured to display the amount for a 10% tip and the amount for a 15% tip. The customer can press button C1 to select the 10% tip amount or button C2 to select the 15% tip amount. Alternatively the user may enter a specific dollar amount for the tip. In other embodiments, the customer may have the option of specifying another specific percentage using the keypad 12 instead of entering a dollar amount for the tip. The device will then automatically calculate the tip using this percentage. Again, the customer can press the CANCEL key or button C3 to clear. When the customer has entered the tip he or she wishes to pay, the ENTER key is pressed to complete this step. The process returns to the payment summary edit step at 500. Further changes can be made by pressing button C1 to select a payment to edit. If no more changes are necessary, the user can press the CANCEL key to return to the payment summary.

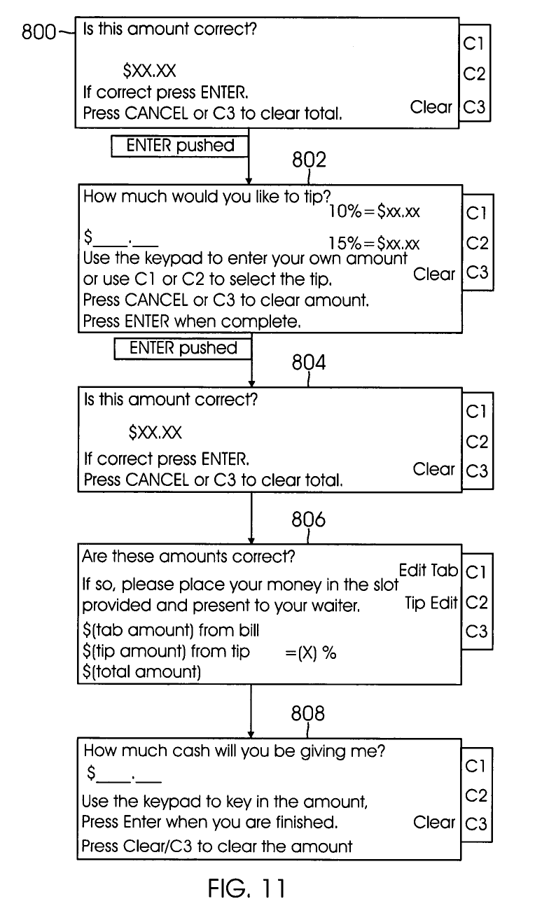

If the user presses button C1 in step 100 of FIG. 4 to select a whole-check payment process, the whole-check payment process takes the user to flow diagram of FIG. 9. In step 600 the device prompts the user to press button C2 for payment by charge card or button C3 for payment by cash. If button C2 is pressed, the process continues with the flow diagram of FIG. 10. If button C3 is pressed, the process moves to the flow diagram of FIG. 11.

FIG. 10 is a flow diagram illustrating a charge card processing step in the whole-check payment process of FIG. 9. In step 700 the device preferably prompts the user to confirm the amount of the bill by pressing the ENTER key or, if the amount is incorrect, to press the CANCEL key or button C3 to clear and enter a new amount using the keypad 12 and then press the ENTER key to confirm. In step 702, the device then asks the user to enter a tip amount. For the customer's convenience and reference, the device is preferably configured to display the amount for a 10% tip and the amount for a 15% tip. The customer can press button C1 to select the 10% tip amount or button C2 to select the 15% tip amount. Alternatively, the user may enter a specific dollar amount for the tip using the keypad. In other embodiments, the customer may have the option of specifying a percentage using the keypad 12 instead of entering a dollar amount for the tip. In these embodiments, the device will preferably automatically calculate the tip amount using this percentage. Again, the customer can press the CANCEL key or button C3 to clear. When the customer has entered the tip he or she wishes to pay, the ENTER key is pressed to complete this step.

In step 704 the device then displays a summary of the bill and the tip to be paid as specified by the customer, and asks the customer to swipe the charge card using the card reader 18 if the amounts are correct. Otherwise, the customer can press button C1 to edit the tab to be paid or press button C2 to edit the tip only. Pressing button C1 takes the user back to step 700, while pressing button C2 takes the user back to step 702 and the amount of the tab specified previously is stored. If the charge card is a debit card, the process goes to step 706. If the charge card is a credit card, the process goes to step 708.

In step 704 where a debit card is used, the device preferably prompts the customer to enter the PIN number using the keypad 12. If the customer makes a mistake, he or she can press the CANCEL key or button C3 to clear and re-enter the PIN number. After the correct PIN number is entered, the customer can press the ENTER key to complete this step. In a preferred embodiment, the remote payment device 10 processes the debit card payment so that there is no need to wait for a payment confirmation at the central payment processing station 30.

In step 704 where a credit card is used, the device preferably prompts the customer to place the card in the slot 20 provided on the remote payment device 10, and shows the amount that will be charged to the credit card.

FIG. 11 is a flow diagram illustrating a cash processing step in the whole-check payment process of FIG. 9. As shown in FIG. 11, at step 800 the device preferably prompts the user to confirm the amount of the bill by pressing the ENTER key or, if the amount is incorrect, to press the CANCEL key or button C3 to clear and enter a new amount using the keypad 12 and then press the ENTER key to confirm. In step 802 the device then asks the user to enter the tip amount. For the customer's convenience and reference, the device is preferably configured to display the amount for a 10% tip and the amount for a 15% tip. The customer can press button C1 to select 10% tip or button C2 to select the 15% tip. Alternatively, the user may enter a specific dollar amount for the tip. In other embodiments, the customer may have the option of specifying a percentage using the keypad 12 instead of entering a dollar amount for the tip. In this embodiment, the device will then automatically calculate the tip amount using this percentage. Again, the customer can press the CANCEL key or button C3 to clear. When the customer has entered the tip he or she wishes to pay, the ENTER key is pressed to complete this step. In step 804, which is optional, the device displays the tip amount and asks the user to confirm the tip amount by pressing the ENTER key or to change/edit the tip amount by pressing the CANCEL key or button C3 to clear and enter a new and correct tip amount using the keypad 12. The user/customer will then press the ENTER key to complete this step.

In step 806 the device then displays a complete summary of the bill and the tip to be paid as specified by the customer, and asks the customer to place the cash in the slot 20 of the remote payment device 10. If any changes are desired, the customer can press button C1 to edit the tab to be paid or press button C2 to edit the tip only. Pressing button C1 takes the user back to step 800, while pressing button C2 takes the user back to step 802 and the amount of the tab specified previously is stored. After the correct amounts are shown, the user will then press ENTER and be taken to step 808.

In step 808 the device asks the customer to enter the amount of cash he or she has placed in the slot 20 using the keypad 12. The customer can press the CANCEL key or button C3 to clear any mistakes. The remote payment device 10 preferably calculates the amount of change, if any, that needs to be returned to the customer.

After all customer inputs have been completed and the bill and tip have been completed entered, tabulated and paid, the display 16 will preferably display a message asking the customer to hand the remote payment device 10 to the waiter or waitress. The waiter and waitress will complete the payment transactions, print the receipts, and give the receipts as well as any change to the customers.

The remote payment device advantageously does not require an affixed bar code or the like for identification. Instead, using standard issued and previously obtained waiter cards which contain server information included in a magnetic stripe, a waiter can swipe his server card using the card reader 18 to load server information and access a waiter-only menu on the display 16 of the remote payment device 10. Using this menu, the waiter will be able to input the table number and load the amount of the total bill, thereby linking the remote payment device 10 to the correct transaction within the central payment processing station 30. Alternatively, the waiter will also have the option of pressing two unique buttons simultaneously to access the waiter-only menu on the display 16 of the remote payment device 10. The waiter can also opt to input the total bill, or the device 10 can be configured to allow the customer to input the total as it appears on the receipt.

The remote payment process has been described for a table service restaurant setting. The present invention is not limited to such a setting, but may be applied in various remote payment situations. In addition, while the split-check scenario has been described for payment by multiple customers, it can be applied to payment by multiple payment methods by a single customer who may wish to pay different portions of the bill by different charge cards and/or cash. Thus, the same customer in the above example may pay a portion of the bill using one charge card and another portion of the bill using another charge card or by cash. Furthermore, the remote payment device described above is a handheld, wireless device. In alternative embodiments, the remote payment device may be permanently attached to a table or a location where the customers can access to make payments, and can be coupled via a wired or wireless connection to the central payment processing station. In other alternative embodiments, the remote payment device does not wirelessly transmit information to the central payment process station, but instead is physically connected to or plugged into the central payment processing station for transmission of payment data after the payment information is collected from the customers (e.g., by a USB connection or the like). Furthermore, the cash payment option can easily be extended to include payment by check such as traveler's check or personal check assuming that certain verification procedures are followed. Therefore, just as the term “charge card” is intended to cover various credit cards, debit cards, gift cards, and the like, the term “cash” is intended to cover not only cash but also cash-equivalents including various checks upon verification.

Although preferred embodiments of this invention have been described above with a certain degree of particularity, those skilled in the art could make numerous alterations to the disclosed embodiments without departing from the spirit or scope of this invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A remote payment device for processing payment of a bill to allow payment to be shared by a plurality of customers, the remote payment device comprising:
a charge card reading unit configured to read account information from a charge card;
a data input unit for a user to input data;
a display unit; and
a processor configured to process account information read from the charge card reading unit and data received from the data input unit and to display information on the display unit, the processor being configured to prompt entry of data by a customer via the data input unit, said data specifying a number of one or more customers to make payment of a bill and then allowing each of said one or more customers to specify a method of payment, an amount of the bill to pay, and any amount of a tip to be added.

2. The remote payment device of claim 1 wherein the processor is configured to allow each of said one or more customers to specify an amount of the bill to pay by allowing each of said one or more customers to select, via the data input unit, any items of the bill to pay, said processor thereafter summing the items entered by the customer to calculate a total from the bill to be paid by said customer.

3. The remote payment device of claim 1 wherein the processor is configured to allow each of said one or more customers to specify any amount of tax to be added for payment.

4. The remote payment device of claim 1 wherein the processor is configured to allow each of said one or more customers to specify any amount of a tip to be added by specifying a dollar amount of the tip or a percentage of the portion of the bill to be paid as the tip.

5. The remote payment device of claim 1 wherein the processor is configured to display on the display unit a payment summary for each of said one or more customers, said payment summary including a method of payment and an amount specified to be paid.

6. The remote payment device of claim 5 wherein when a payment method is by a charge card, the display unit will display the last four digits on the charge card.

7. The remote payment device of claim 5 wherein the processor is configured to calculate and display on the display unit any remaining amount of the bill that still needs to be paid.

8. The remote payment device of claim 1 wherein for payment by a debit card, the processor is configured to prompt the customer to enter a PIN number using the data input unit.

9. The remote payment device of claim 1 wherein for payment by a credit card, the processor is configured to prompt the customer to place the credit card in a slot on the remote payment device.

10. The remote payment device of claim 1 wherein for payment by cash, the processor is configured to prompt entry of a cash amount to be provided by the customer, and wherein any excess cash provided by the customer is to be returned as change.

11. The remote payment device of claim 10 wherein the processor is configured to calculate the change to be returned to the customer.

12. The remote payment device of claim 1 further comprising a wireless interface to communicate payment information wirelessly with a central payment processing station.

13. A remote payment device for processing payment of a bill shared by a plurality of customers, the remote payment device comprising:
a charge card reading unit configured to read account information from a charge card;
a data input unit for a user to input data;
a display unit; and
a processor configured to process account information read from the charge card reading unit and data received from the data input unit and to display information on the display unit, the processor being configured to allow each customer in the plurality to specify a method of payment and any amount of the bill to pay, and any tip to be added.

14. The remote payment device of claim 13 wherein the processor is configured to allow each customer to specify any amount of a tip to be added by specifying a dollar amount of the tip or a percentage of the portion of the bill to be paid as the tip.

15. The remote payment device of claim 13 wherein the processor is configured to allow each of said one or more customers to specify any amount of tax to be added for payment

16. The remote payment device of claim 13 wherein the processor is configured to display on the display unit a payment summary for each customer in the plurality, said summary including an amount specified by said customer to be paid and a total amount of any tip.

17. A method of remotely processing payment of a bill to allow payment to be shared by a plurality of customers, the method comprising:
prompting entry of a number of one or more customers to make payment of a bill; and
prompting entry of data for each customer to specify any amount of the bill to pay without regard to items on the bill ordered or consumed by the customer and any amount of a tip to be added and a method of payment.

18. The method of claim 17 wherein prompting entry of data for each customer to specify any amount of the bill to pay comprises:
receiving from the customer data specifying any items of the bill to pay; and
summing the items specified by the customer to calculate a total from the bill to be paid by the customer.

19. The method of claim 17 wherein prompting of entry of data for each customer comprises:
each customer specifying any amount of a tip to be added by either specifying a specific dollar amount of the tip or a percentage of the portion of the bill to be paid as the tip.

20. The method of claim 17 wherein the prompting of entry of data for each customer comprises:
each customer specifying any amount of tax to be added for payment.

21. The method of claim 17 further comprising:
displaying a payment summary for each customer on the display unit, said summary including a method of payment, an amount specified by each customer to be paid and any amount of a tip to be added; and
allowing the customer to edit the amount before finalizing payment.

22. The method of claim 21 wherein the payment summary includes displaying a customer name and the last four digits on a charge card when the method of payment is by a charge card.

23. The method of claim 21 further comprising:
calculating and displaying any remaining amount of the bill that needs to be paid after each customer specifies an amount of the bill to be paid.

24. The method of claim 21 further comprising communicating payment information wirelessly with a central payment processing station.

25. The method of claim 21 further comprising, for a method of payment by cash, prompting entry of a cash amount to be provided by the customer, wherein any excess cash provided by the customer is to be returned as change.

26. The method of claim 25 further comprising calculating the change to be returned to the customer.

27. A remote payment device for processing multiple payments on a single bill shared by a plurality of customers, the remote payment device comprising:
a charge card reading unit configured to read account information from a charge card;
a data input unit for a user to input data;
a display unit; and
a processor configured to process account information read from the charge card reading unit and data received from the data input unit and to display information on the display unit,
wherein the remote payment device is configured to receive input data specifying a number of one or more customers making payment on the single bill, and input data from each of said number of one or more customers specifying a method of payment, an amount of the bill to pay, and any amount of a tip to be added; and further wherein the remote payment device automatically calculates and displays any remaining amount of the bill that needs to be paid after each of said number of one or more customers inputs data specifying the method of payment, the amount of the bill to pay, and the amount of any tip to be added.

28. The remote payment device of claim 27, wherein the processor is configured to allow each of said number of one or more customers to specify any amount of the bill to pay by allowing each of said number of one or more customers to select specific items of the single bill to be paid and thereafter summing the total for those items selected in order to determine the total from the bill to be paid by each of said number of one or more customers.

29. The remote payment device of claim 27, wherein the device is configured to allow each of said number of one or more customers to specify any amount of the bill to pay by inputting a specific dollar amount of the bill to be paid by each of said number of one or more customers.

30. The remote payment device of claim 27, wherein the device is configured to allow each of said number of one or more customers to specify any amount of a tip to be added by specifying either a dollar amount for such tip or a percentage of a portion of the bill to be paid as the tip.

31. The remote payment device of claim 27, wherein the processor is configured to display on the display unit a payment summary for each of said one or more customers, said payment summary including a total amount paid on the bill, each individual amount specified by each of said number of one or more customers to be paid, and a total amount of any tip.

32. The remote payment device of claim 27, further comprising a wireless interface to communicate payment information for each of said number of one or more customers wirelessly with a central payment processing station.
